(19) United States
(12) Patent Application Publication
(10) Pub. No.: US 2023/0065260 A1
(43) Pub. Date: Mar. 2, 2023

(54) INTELLIGENT MANUFACTURING INDUSTRIAL INTERNET OF THINGS BASED ON PLATFORM NETWORKS IN POST-SUB TYPE AND CONTROL METHODS THEREOF

(71) Applicant: CHENGDU QINCHUAN IOT TECHNOLOGY CO., LTD., Chengdu (CN)

(72) Inventors: Zehua SHAO, Chengdu (CN); Haitang XIANG, Chengdu (CN); Bin LIU, Chengdu (CN); Xiaojun WEI, (US); Yaqiang QUAN, Chengdu (CN)

(73) Assignee: CHENGDU QINCHUAN IOT TECHNOLOGY CO., LTD., Chengdu (CN)

(21) Appl. No.: 18/049,621

(22) Filed: Oct. 25, 2022

(51) Int. Cl. G05B 23/02

(52) U.S. Cl. CPC G05B 23/0251; G05B 23/0294; G05B 23/0272

(57) ABSTRACT

The embodiments of the present disclosure disclose an intelligent manufacturing Industrial Internet of Things based on a platform network in a post-sub type and control methods thereof. The Industrial Internet of Things includes a management platform, which includes a plurality of management sub-platforms and a general platform database, wherein each of the management sub-platforms performs production calculation based on first operation data to generate first calculation result data, and sends the first calculation result data to the general platform database; and the general platform database performs the production calculation based on second operation data to generate second calculation result data, and generates adjustment parameters of production devices according to the second calculation result data and the first calculation result data.

### TECHNICAL FIELD

The present disclosure relates to a field of an intelligent manufacturing Industrial Internet of Things based on a platform network in a post-sub type.

### BACKGROUND

In the prior art, an adjustment of device parameters on an intelligent manufacturing industrial production line needs to form a complete adjustment closed loop, i.e., an intelligent management center adjusts the device parameters according to the feedback data from production devices and sensors, thereby realizing a real-time adjustment of a device on the production line. However, the data fed back by the sensors may be affected by a plurality of devices, which is not conducive to the accuracy of the real-time adjustment of device parameters.

### SUMMARY

According to one aspect of the embodiments in the present disclosure, an intelligent manufacturing Industrial Internet of Things based on a platform network in a post-sub type is provided. The Industrial Internet of Things includes a management platform, which includes a plurality of management sub-platforms and a general platform database, wherein each of the management sub-platforms performs production calculation based on first operation data to generate first calculation result data, and sends the first calculation result data to the general platform database; and the general platform database performs the production calculation based on second operation data to generate second calculation result data, and generates adjustment parameters of production devices according to the second calculation result data and the first calculation result data.

According to the other aspect of the embodiments in the present disclosure, a method of the intelligent manufacturing Industrial Internet of Things based on the platform network in the post-sub type is provided, wherein the Industrial Internet of Things includes a service platform, a management platform, and a sensor network platform that interacts in sequence, and the management platform includes a plurality of management sub-platforms and a general platform database, and the control method includes: performing, by each of the management sub-platforms, the production calculation based on first operation data to generate first calculation result data, and sending the first calculation result data to the general platform database; and performing, by the general platform database, the production calculation based on second operation data to generate second calculation result data, and generating adjustment parameters of the production devices according to the second calculation result data and the first calculation result data.

Compared with the prior art, the present disclosure has the following advantages and beneficial effects.

The intelligent manufacturing Industrial Internet of Things based on the platform network in the post-sub type and the control method thereof in the present disclosure not only adjust an individual device but also perform a whole adjustment on parameters of a whole production line, which effectively improves the accuracy of a real-time adjustment of the device parameters. In some embodiments of the present disclosure, the adjustment parameters of the production devices are predicted through the first calculation result data, the second calculation result data, a production sequence, and a non-automation factor in each production link, which considers not only an individual production situation of each production device but also the overall feedback data of the whole production line and a mutual influence between the devices. The influence of human participation degree on the production results is also considered, which predicts the adjustment parameters of the production devices more accurate.

### BRIEF DESCRIPTION OF THE DRAWINGS

The present disclosure will be further described in the form of exemplary embodiments, which will be described in detail by the accompanying drawings. These embodiments are not limiting, in these embodiments, the same number denotes the same structure, wherein:

FIG. 1 is an exemplary block diagram illustrating an Intelligent manufacturing Industrial Internet of Things based on a platform network in a post-sub type according to some embodiments of the present disclosure;

FIG. 2 is an exemplary flowchart diagram illustrating an intelligent manufacturing Industrial Internet of Things based on a platform network in a post-sub type according to some embodiments of the present disclosure;

FIG. 3 is an exemplary schematic diagram illustrating generating first calculation result data based on a first calculation model according to some embodiments of the present disclosure;

FIG. 4 is an exemplary schematic diagram illustrating generating second calculation result data based on a second calculation model according to some embodiments of the present disclosure;

FIG. 5 is an exemplary schematic diagram illustrating determining adjustment parameters of a production device based on a parameter determination model according to some embodiments of the present disclosure;

FIG. 6 is an exemplary schematic diagram illustrating model training according to some embodiments of the present disclosure;

### DETAILED DESCRIPTION

To more clearly illustrate the technical solutions related to the embodiments of the present disclosure, a brief introduction of the drawings referred to the description of the embodiments is provided below. Obviously, the accompanying drawing in the following description is merely some examples or embodiments of the present disclosure, for those skilled in the art, the present disclosure may further be applied in other similar situations according to the drawings without any creative effort. Unless obviously obtained from the context or the context illustrates otherwise, the same numeral in the drawings refers to the same structure or operation.

It should be understood that the term “system,” “device,” “unit,” and/or “module” used herein are one method to distinguish different components, elements, parts, sections, or assemblies of different levels in ascending order. However, if other words may achieve the same purpose, the words may be replaced by other expressions.

As used in the disclosure and the appended claims, the singular forms “a,” “an,” and “the” include plural referents unless the content clearly dictates otherwise; the plural forms may also include the singular forms as well. Generally speaking, the terms “comprise” and “include” only imply that the clearly identified steps and elements are included, and these steps and elements may not constitute an exclusive list, and the method or device may further include other steps or elements.

Flow charts are used throughout the present disclosure to illustrate the operations performed by the system according to embodiments of the present disclosure. It should be understood that the preceding or following operations are not necessarily performed in precise order. Instead, the individual steps may be processed in reverse order or simultaneously. It is also possible to add other operations to these processes or to remove a step or steps of operations from these processes.

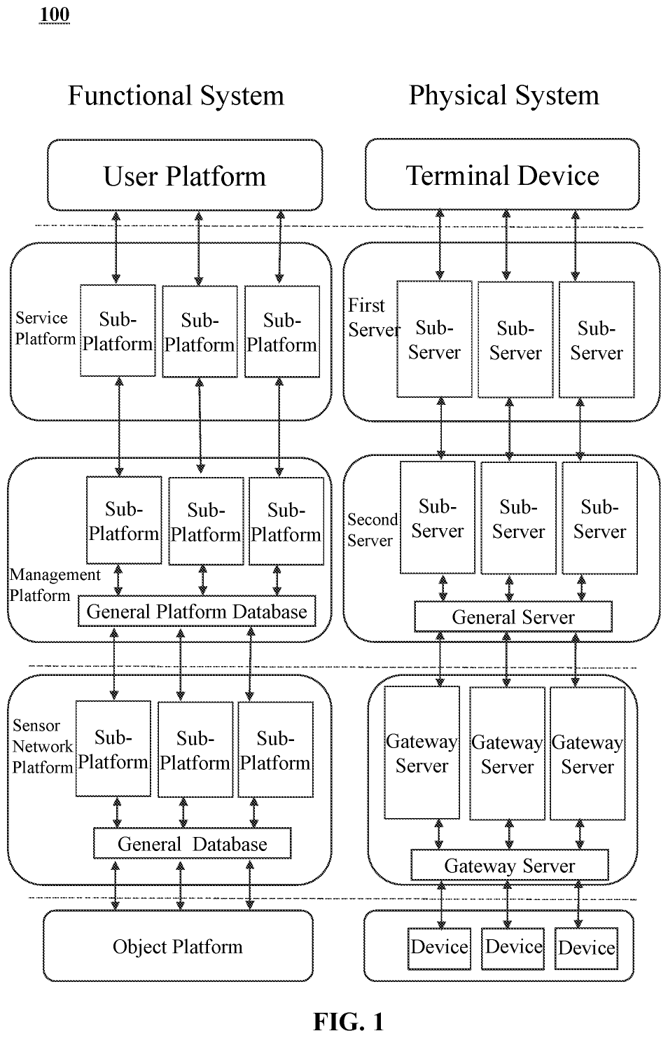

FIG. 1 is an exemplary block diagram illustrating an Intelligent manufacturing Industrial Internet of Things based on a platform network in a post-sub type according to some embodiments of the present disclosure.

As shown in FIG. 1, the intelligent manufacturing Industrial Internet of Things based on a platform network in the post-sub type includes a user platform, a service platform, a management platform, a sensor network platform, and an object platform. In some embodiments, the intelligent manufacturing Industrial Internet of Things 100 based on a platform network in the post-sub type may be part of a server or performed by a server.

The Industrial Internet of Things may process information, and its processing of information may be divided into the processing of perception information and the processing of control information, and the control information may be the information generated based on the perception information. The processing of perception information is obtained by the object platform and transmitted to the management platform through the sensor network platform, the management platform transmits the calculated perception information to the service platform and finally to the user platform, and the user generates control information after judging and analyzing the perception information. The control information is generated by the user platform and sent to the service platform, the service platform then transmits the control information to the management platform, and the management platform calculates the control information and sends it to the object platform through the sensor network platform, thereby realizing the control of the corresponding object.

The user platform may be a user-oriented service interface configured to interact with the user. In some embodiments, the user platform may be configured as a terminal device, for example, the terminal device may include a mobile device, a tablet computer, etc., or any combination thereof. In some embodiments, the user platform may be configured to receive data and/or information sent by the management platform through the service platform. For example, the user platform may receive classified data packets sent by the management platform through the service platform.

The service platform may be a platform that realizes an interface between the management platform and the user platform for receiving and transmitting data and/or information. For example, the service platform may send classified data packets sent by the management platform to the user platform. In some embodiments, the service platform may be arranged in a standalone arrangement. The standalone arrangement may refer to a service platform using different sub-platforms for data storage, data processing, and/or data transmission for different types of data or data from different sources. In some embodiments, the service platform may be configured as a plurality of service sub-platforms, each of the sub-platforms may receive the corresponding classified data packets and send them to the user platform.

The management platform may refer to an Internet of Things platform that arranges and coordinates the connection and collaboration among the functional platforms and provides perception management and control management. For example, the management platform may obtain the first operation data and the second operation data of all production devices in the object platform through the sensor network platform.

In some embodiments, the management platform may be arranged in a front-sub type. The front-sub type arrangement may mean that the management platform is arranged with a general platform database and a plurality of management sub-platforms, wherein the plurality of management sub-platforms store, process, and/or transmit the corresponding data according to different data sources; each management sub-platform may further aggregate the processed data to the general platform database; and the general platform database analyzes and stores the data based on the aggregated data, and then transmits the data through the general platform database to the user platform or transmits the data to the object platform through the sensor network platform. For example, each management sub-platform may perform a production calculation based on the first operation data to generate the first calculation result data and send it to the general platform database, and the general platform database may perform the production calculation based on the second operation data to generate second calculation result data and generate adjustment parameters of the production device based on the second calculation result data and the first calculation result data. As well, the general platform database may send the adjustment parameters to the corresponding production device to adjust the production device through the sensor network platform, and send the classified data package to the user platform for classification display through the service platform.

The sensor network platform may be a platform that realizes an interface between the management platform and the object platform for interaction. In some embodiments, the sensor network platform may connect the management platform and the object platform to realize functions of perception information sensing communication and control information sensing communication. In some embodiments, the sensor network platform may be arranged in a front-sub type, the front-sub type arrangement means that the sensor network platform includes a general database of the sensor network platform and a plurality of sensor network sub-platforms, each of the sensor network sub-platforms receives different types of classified data packets from the general database of the sensor network platform.

The object platform may be a functional platform for the generation of perception information and the final execution of controlling information. In some embodiments, the object platform may be configured to include at least one production device. In some embodiments, the relevant operation data of the production device may be uploaded to the general database of the sensor network platform and sent to the general platform database of the management platform through the corresponding sensor network sub-platform.

It is possible for those skilled in the art, after understanding the principle of this Industrial Internet of Things, to transpose the intelligent manufacturing Industrial Internet of Things 100 based on a platform network in the post-sub type to any other suitable scenario without departing from this principle.

It should be noted that the above description of the Industrial Internet of Things and its modules is for descriptive convenience only and does not limit the present disclosure to the scope of the embodiments cited. Understandably, for those skilled in the art, after understanding the principle of the system, it may be possible to make any combination of each module or form a sub-system to connect with other modules without departing from this principle. For example, each module may share a common memory module, and each module may have its memory module. Variations such as these are within the scope of protection of the present disclosure.

To facilitate the description of the above intelligent manufacturing Industrial Internet of Things based on the platform network in the post-sub type, a schematic diagram illustrating the communication architecture of the intelligent manufacturing Industrial Internet of Things based on the platform network in the post-sub type disclosed in the embodiment of the present disclosure is provided with reference to FIG. 1. The intelligent manufacturing Industrial Internet of Things based on the platform network in the post-sub type may include a service platform, a management platform, and a sensor network platform interacting in sequence.

The sensor network platform includes a general database of the sensor network platform and the plurality of sensor network sub-platforms.

The general database of the sensor network platform is configured to receive the operation data of all production devices in the object platform and to pack the operation data into classified data packages according to the production lines in which the corresponding production devices are located.

Each of the plurality of sensor network sub-platforms is configured to receive different types of classified data packets from the general database of the sensor network platform.

A general platform database of the management platform is configured to interact with the sensor network sub-platforms through different ports and to receive the classified data packets as the second operation data.

Each of a plurality of management sub-platforms is configured to receive a corresponding classified data package from the general platform database as the first operation data.

The general platform database sends the adjustment parameters to the corresponding production devices through the sensor network sub-platforms to adjust the production devices.

The general platform database sends the classified data packets to the user platform through the service platform and displays the classified data packets to the user platform in a classified manner.

When the embodiment of the present disclosure is performed, the inventor finds in scientific practice that in the prior art, the evaluation of the product situation on the production line is mainly performed through various sensors for the detection of product-related situations, and although this method is intuitive and effective, for some production lines with more complex working conditions, it is difficult to determine which device affects parameters of a certain product because the product comes out of one production line, and the analysis of the production parameters of each device also makes it difficult to determine the influence between the devices.

When the embodiment of the present disclosure is performed, this embodiment adopts a five-platform structure previously designed and used by the inventor, which will not be repeated herein. The general database of the sensor network platform acts as the general gateway server for the packaging of the operation data, to complete the classification of the operation data right in the network transmission. The classification may be performed according to the device ID in the prior art, or other ways that can be used to classify the data of different production lines of the device, which will be not much limited in the embodiment. In the present disclosure, a plurality of different sensor network sub-platforms are used for the transmission of different classified data packets, and each sensor network sub-platform corresponds to a different interface of the general platform database, which can facilitate the sorting and storage processing of the classified data packets by the general platform database.

When the embodiment of the present disclosure is performed, the general platform database receives the classified data packets at different ports, and it is possible to know which production line the classified packet corresponds to without reading the packet, and then directly stores and distributes the classified data packets to the corresponding management sub-platforms for analysis, which effectively improves the efficiency of data packet distribution, and there is no need to unpack the classified data packet before the general platform database processes the classified data packet. At the same time, the management sub-platform performs the calculation on the received classified data packets and simulates the production situation of the production line corresponding to each classified data packet as the first calculation result data.

In the embodiment of the present disclosure, the general platform database also performs the calculation of all the classified data packets to simulate the production of the whole production line as the second calculation result data; it should be understood that the first calculation result data and the second calculation result data may be numerical results, which can be realized by the numerical representation in the prior art to represent the production situation of the production line. The first calculation result data and the second calculation result data may represent the numerical product defect situation, the numerical production line operation state, etc., which are not limited in this embodiment.

The combination of the first and second calculation results data allows for the correction and adjustment of production device parameters, both for a single device and for the entire production line, effectively improving the accuracy of real-time adjustment of device parameters.

In the embodiment of the present disclosure, a user platform is configured as a terminal device, and interacts with a user; a service platform is configured as a first server, and extracts information needed to process the user platform from the management platform and sends it to the user platform, a management platform is configured as a second server, and controls the object platform operation and receives feedback data from the object platform, a sensor network platform is configured as a communication network and gateway for the interaction between object platform and the management platform, and an object platform is configured to perform manufacturing of production line devices and production line sensors.

In one possible implementation, the service platform includes:

a plurality of service sub-platforms, each of which is configured to receive the corresponding classified data packet and send the corresponding classified data packet to the user platform.

When the embodiment of the present disclosure is performed, service platforms with the standalone arrangement are used, i.e., each service sub-platform corresponds to different classified data packets for data transmission to the user platform to improve the data transmission efficiency and the receiving and processing efficiency of the user platform.

In a possible implementation, the management sub-platform is configured with a first calculation model corresponding to the classified data packets.

The management sub-platform inputs the operation data received in the classified data packages into the first calculation model and receives the output data output by the first calculation model as the first calculation result data.

The first calculation model simulates the production link of the production line corresponding to the classified data package according to the classified data package and generates evaluation data of the output product of the production line as the first calculation result data.

When the embodiment of the present disclosure is performed, the first calculation model is a prefabricated model that simulates the virtual operation of a section of the production line, and there is a plurality of ways to generate the model, which will not be limited here. The advantage of this model is that the generation process is existing, and the generation method is simple because each first calculation model corresponds to only one section of the production line. By inputting the corresponding classified data packets into the first calculation model, it is possible to simulate the production of the production line during the generation of these classified data packets. To estimate the production line directly from the results, the evaluation data of the output products of the production line is used as the first calculation result data in the embodiments of the present disclosure. Exemplarily, for a section of the screw processing line, the error value of the lead angle of the thread can be simulated and calculated as part of the first calculation result data.

In a possible implementation, the general platform database is configured with a second calculation model corresponding to all the production lines in the object platform and a production link corresponding to all the production lines in the object platform as queue data.

The general platform database sorts all the classified data packets to form a production sequence based on the queue data and inputs the classified data packets sequentially into the second calculation model starting at the top of the production sequence.

Each time receiving the classified data packets, the second calculation model simulates the production link for all the classified data packets already received and generates the evaluation data of the output product as the second calculation result data corresponding to the current classified data packets.

In the implementation of the embodiments of the present disclosure, similar to the process in the above embodiment, the second calculation model prefabricated on the general platform database is a model for virtual operation simulation for the entire production line, and there are many ways to generate such a model, which will not be limited here. In the present disclosure, the general platform database sorts the classified data packages and inputs them to the second calculation model for simulation, and the output data after each simulation is used as the second calculation result data, which also uses the evaluation data of the output products of the production line to correspond to the first calculation result data for subsequent calculations.

Exemplarily, the whole production line has three sub-production lines A→B→C. A, B, and C correspond to different classified data packets; at the beginning of the calculation of the second calculation model, the classified data packet corresponding to A may be input into the second calculation model, and the output second calculation result data is corresponding to A; then the classified data packet corresponding to B may be input into the second calculation model, and the second calculation result data corresponding to B may be calculated based on the calculation of the classified data packet corresponding to A, similarly, the second calculation result data corresponding to C may be calculated.

Exemplarily, the whole production line has three sub-production lines A→B→C, A, B, and C may all correspond to different classified data packets; at the beginning of the calculation of the second calculation model, the classified data packet corresponding to A may be input into the second calculation model, and the output second calculation result data is corresponding to A; then the classified data packet corresponding to B and the classified data packet corresponding to A may be input into the second calculation model, and the second calculation result data corresponding to B may be calculated, similarly, the second calculation result data corresponding to C may be calculated.

In a possible implementation, the general platform database, when generating the adjustment parameters for the production device based on the second calculation result data and the first calculation result data, obtains the differences between the second calculation result data and the first calculation result data corresponding to the same classified data package.

The general platform database averages the second calculation result data and the first calculation result data to form a prediction production result and generates the adjustment parameters for the production device based on the prediction production result.

When the embodiment of the present disclosure is performed, since the first and second calculation result data are continuously generated, it is difficult to identify which of the first and second calculation result data can more accurately express the actual situation of the production line, so in the embodiment of the present disclosure, the two are taken equally and the parameters adjustment of the production device is performed on operations time after time, realizing the iteration of the parameters adjustment of the production device. This method of taking the average value generally makes this iteration gradually convergent and reach a good effect. In the embodiment of the present disclosure, the generation of the adjustment parameters of the production device according to the predicted production results is already available in the prior art and will not be repeated herein, and can generally be obtained by interpolation and other methods.

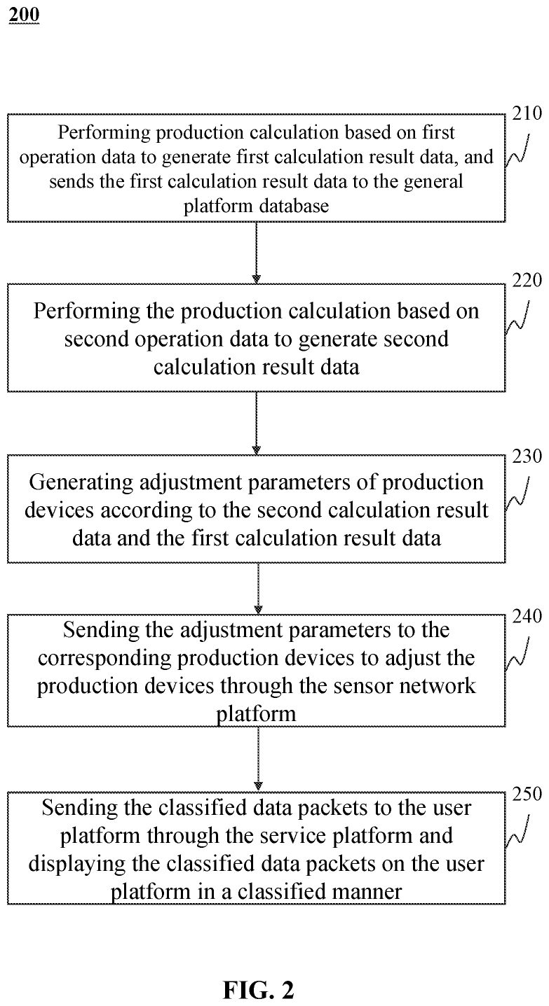

FIG. 2 is an exemplary flowchart diagram illustrating an intelligent manufacturing Industrial Internet of Things based on a platform network in a post-sub type according to some embodiments of the present disclosure. As shown in FIG. 2, process 200 includes the following steps.

Step 210, performing the production calculation based on the first operation data to generate the first calculation result data, and sending it to the general platform database. In some embodiments, step 210 may be performed by the management sub-platforms.

The process of manufacturing the product may include at least one production line, each production line including at least one production link, and each production link is configured with a class of production devices for production. More descriptions regarding the production devices may be found in step 230 and its related description.

The first operation data may refer to the related data corresponding to the operation of one of the production links during the operation of the production line. In some embodiments, the intelligent manufacturing Industrial Internet of Things is used in a production line for the production of cream-based cosmetics. For example, in a cream cosmetics production line, the first operation data may be the related data corresponding to the operation of one of the production links including grinding, emulsification, sterilization, filling, packaging, etc.

In some embodiments, the first operation data may include data such as real-time production state and real-time operation parameters of a production device configured for the corresponding production link. The real-time production state is configured to indicate whether the production device is working properly, and the real-time operation parameters are used to indicate the operation parameters of the production devices. For example, the grinding device is configured to grind the solid raw materials of cream-type cosmetics, and its first operation data includes data such as operating pressure in grinding, grinding gap and grinding manner. For example, (0.04˜0.1 Mpa, 0.3 mm, A1) represents the real-time operating pressure of the grinding device between 0.04˜0.1 Mpa, the grinding gap is 0.3 mm, and the grinding manner is A1 (e.g., A1 is used for fine grinding and A2 is used for coarse grinding).

In some embodiments, the first operation data also includes raw material information and stage standard product information for the corresponding production link. For example, the raw material information includes the class, trait, and ratio of the raw material, etc. The stage standard product information may refer to the standard requirements for the output product of the production link (e.g., including the standard particle size for the output product of the grinding link, the standard emulsification level for the output product of the emulsification link, etc.).

In some embodiments, the first operation data may be formed by the management sub-platforms receiving classified data packets from the general platform database. The classified data packet is formed by the general database of the sensor network platform receiving the operation data of all the production devices in the object platform and classifying and packaging the operation data according to the production lines in which the corresponding production devices is located. The classified data packet includes the operation data of all the production links in a certain production line. Accordingly, the classified data packages may be divided according to the production link in which the production devices are located to form the first operation data. For example, the general database of the sensor network platform receives the operation data of the grinding device, emulsifying device, sterilizing device, filling device, and packaging device in the object platform, the production line in which the production devices are located corresponding to the operation data is a production line of cream cosmetics, then these operation data may be packed to form the classified data packets. Further, the management sub-platform receives the classified data package from the general platform database and divides the classified data package according to the production link in which the production devices are located to form the first operation data, for example, the first operation data of the grinding step (link) corresponding to the grinding device and the first operation data of the filling step corresponding to the filling device, etc.

The first calculation result data may be the product evaluation data obtained without considering the interaction between multiple production links in the production line. For example, the first calculation result data may be the product evaluation data output after the production calculation on the operation data of a single production link. For another example, the first calculation result data may be the product evaluation data output after the production calculation on the operation data of each of a plurality of production links in the production line. The interactions between the production links are not considered when determining the first calculation result data. More descriptions regarding the production calculations may be found in the below description.

Product evaluation data may refer to data that estimates the quality of the output products (e.g., semi-finished products, finished products, etc.) from the production link (or production stage) and/or production line. In some embodiments, the product evaluation data may be measured by production errors.

The production error may reflect the quality deviation between the output product from the production chain and/or production line and the same product of standard quality. The production error may be represented by a value between 0 and 1, and the higher value indicates a greater deviation. Merely as a way of example, the first calculation result data of the cream cosmetics line may include the production error corresponding to each of the grinding link, emulsification link, sterilization link, filling link, and packaging link, i.e., including the first grinding error, the first emulsification error, the first sterilization error, the first filling error, and the first packaging error. The grinding error is the production error of the grinding link, which indicates the deviation of the particle size between the output product of the grinding link and the product of standard quality. The greater the grinding error, the greater the deviation of the particle size of the output product of the grinding link from the particle size of the product of standard quality. Other production errors are similar to the grinding error and will not be repeated herein.

It should be noted that the first calculation result data does not take into account the interaction between production links, accordingly, the first grinding error is the grinding error obtained without taking into account the interaction between production links. The first emulsification error, the first sterilization error, the first filling error, and the first packaging error are similar to the first grinding error and will not be repeated herein.

In some embodiments, the production error may be determined by the proportion of products that do not reach the standard quality. In some embodiments, the production error may also be related to stage standard product information. For example, when the output product of a production link has a lower standard requirement, the production error may be smaller.

In some embodiments, when the first operation data of a plurality of production links on a production line is processed separately, a plurality of the first calculation result data may be output. Accordingly, a first sequence may be configured to represent the first calculation result data of the plurality of production links on the production line. For example, the first sequence is (0.1, 0.2, 0.3, 0.15, 0.05), indicating that the production errors of five production links on a production line are 0.1, 0.2, 0.3, 0.15, 0.05 in order. It should be noted that the production error of each production link in the first sequence do not take into account the influence between production links.

In some embodiments, each management sub-platform of the plurality of management sub-platforms may perform production calculation on the first operation data of the corresponding production link to generate the first calculation result data.

The production calculation may refer to a calculation process in which operation data from a production link is processed by using an algorithm or the like to predict and obtain the product evaluation data. For example, the production calculation may be a calculation process that processes the first operation data by using an algorithm or the like to predict and obtain the first operation result data.

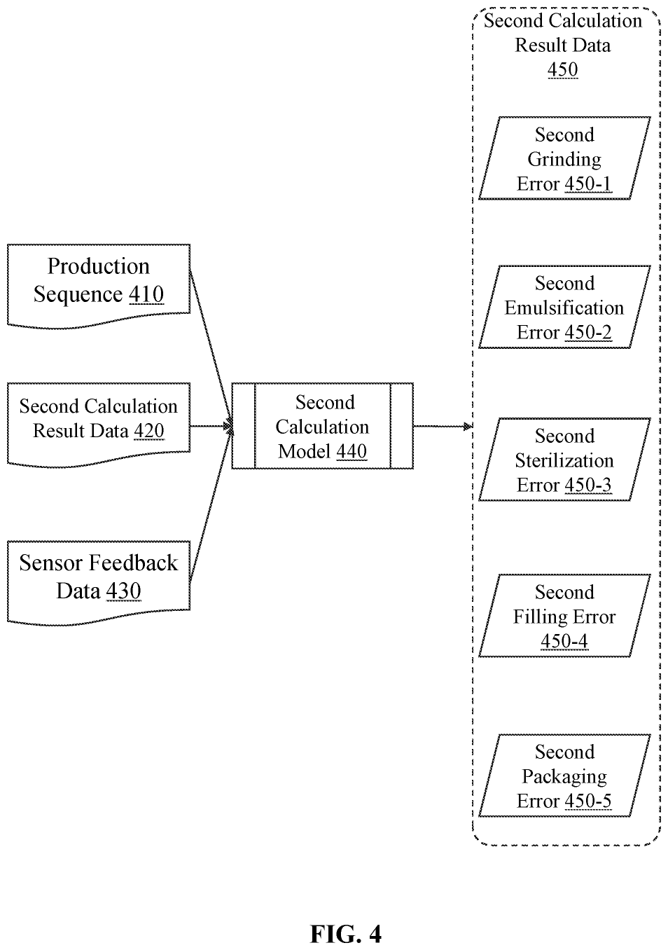

In some embodiments, the first operation data may be input into a first calculation model for production calculation, and the first calculation model simulates the production link corresponding to the first operation data and generates product evaluation data of the production link as the first calculation result data. More descriptions regarding determining the first operation result data may be found in FIG. 2, FIG. 4, and their related descriptions.

Step 220, performing the second calculation result data based on the second operation data to generate the second calculation result data. In some embodiments, step 220 may be performed by the general platform database.

The second operation data may refer to the related data during the operation of all production links of the production line. For example, in a cream cosmetics product line, the second operation data may be the related data during the operation of all production links, including the grinding link, emulsification link, sterilization link, filling link and packaging link, etc.

In some embodiments, the second operation data may include data such as real-time production states and real-time operation parameters of the production devices configured in all production links on the production line and raw material information and stage standard product information for all production links on the production line.

In some embodiments, the second operation data may be formed by the general platform database receiving the classified data packets of one production line through different ports interacting with the sensor network sub-platforms, i.e., the second operation data includes the operation data of all production links in the production line, differing from the first operation data that only includes the operation data of one of the production links in the production line.

The second calculation result data is the product evaluation data obtained by considering the influence between the operating of various production links. For example, the second calculation result data may include a second grinding error, a second emulsification error, a second sterilization error, a second filling error, and a second packaging error. The interactions between the production links are considered when determining the second calculation result data. Accordingly, the second grinding error is the grinding error obtained by considering the interaction between the production links. The second emulsification error, the second sterilization error, the second filling error, and the second packaging error are similar to the second grinding error and are not repeated herein.

In some embodiments, the second calculation result data may include the production error corresponding to each production link. Accordingly, a second sequence may be configured to represent the second calculation result data. The second sequence is similar to the first sequence and will not be repeated. It should be noted that the production error of each production link in the second sequence considers the interaction between the production links.

In some embodiments, the general platform database may generate the second calculation result data based on the second operation data.

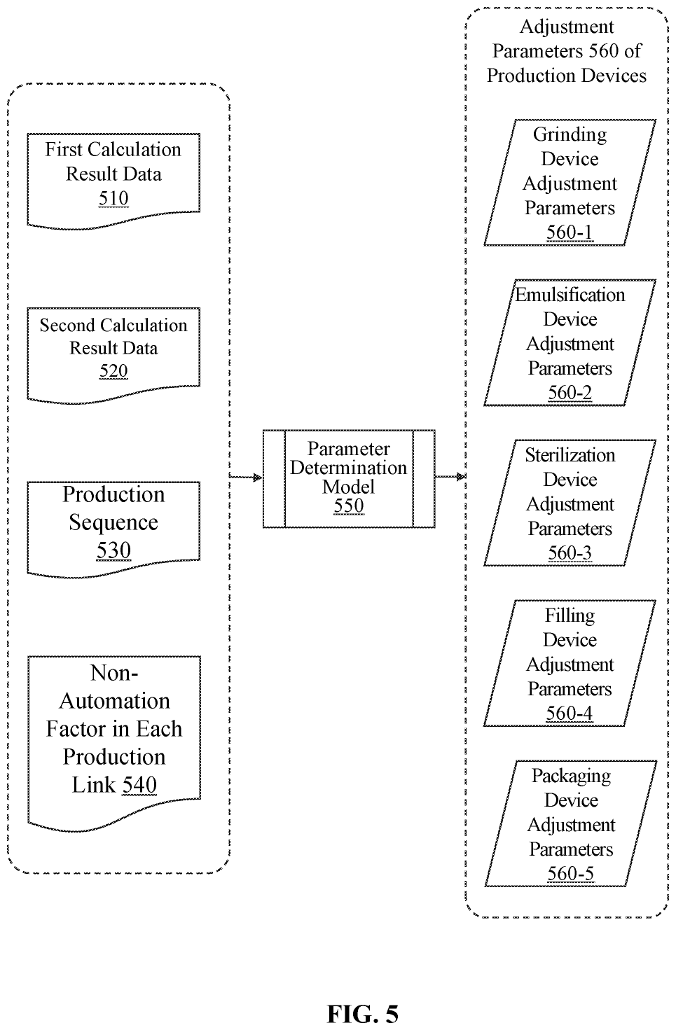

More descriptions regarding the second calculation result data may be found in FIG. 2 and FIG. 5 and their related descriptions.

Step 230, generating the adjustment parameters of the production devices according to the second calculation result data and the first calculation result data. In some embodiments, step 230 may be performed by the general platform database.

The adjustment parameters may be parameters that are used to adjust the production devices. Different production devices may correspond to different adjustment parameters. For example, the adjustment parameters of the grinding device are (0.02 Mpa, 0.1 mm, A2), representing the adjustment of the grinding device including adjusting the operating pressure to 0.02 Mpa, adjusting the grinding gap to 0.1 mm, and adjusting the grinding manner to A2.

The production device includes the device used in the production link. In some embodiments, the production device for the cream cosmetics line includes a grinding device used in the grinding process, an emulsification device used in the emulsification process, a sterilization device used in the sterilization process, a filling device used in the filling process, and a packaging device used in the packaging link. The grinding device is configured to grind the solid ingredients of cream cosmetics, such as a three-roller grinder. The emulsification device is configured to emulsify the liquid ingredients of cream cosmetics, such as an in-line emulsion machine, etc. The sterilization device is used for disinfection and sterilization of cream cosmetics, such as an ethylene oxide sterilizer, etc. The filling device is used for filling cream cosmetics products, such as a cream filling machine, etc. The packaging device is used for packaging cream cosmetics, such as an automatic cartoning machine, etc.

In some embodiments, when the general platform database generates the adjustment parameters of the production devices based on the second calculation result data and the first calculation result data, it obtains the differences between the second calculation result data and the first calculation result data corresponding to the same classified data package, the general platform database averages the second calculation result data and the first calculation result data to form the estimated production result, and generates the adjustment parameters of the production devices based on the estimated production result. More descriptions regarding the embodiment may be found in FIG. 2 and its related description.

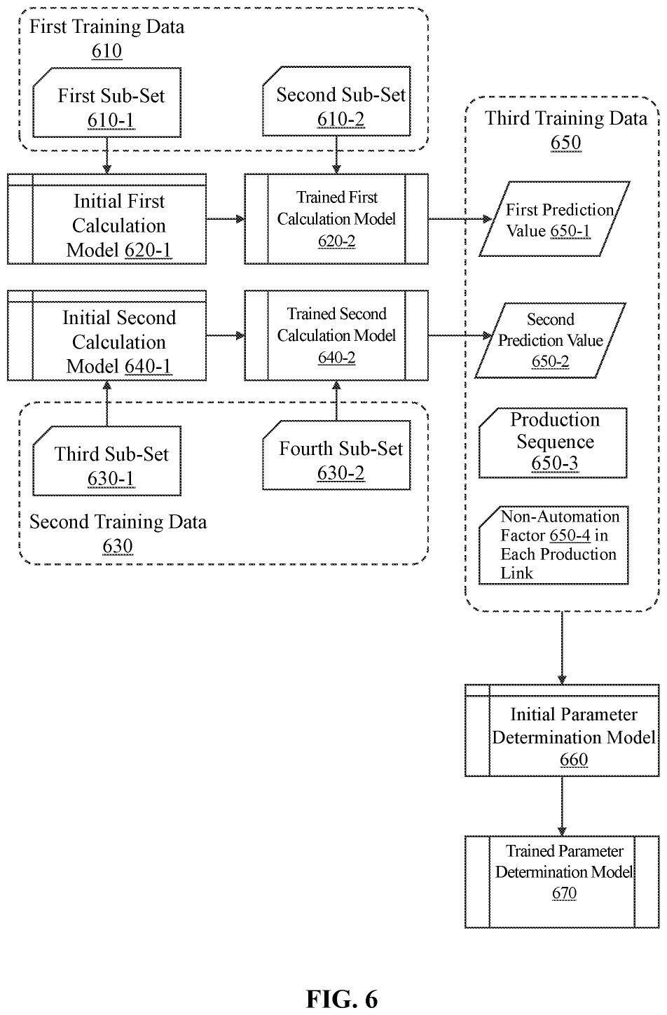

In some embodiments, the adjustment parameters for the production devices may also be generated by a parameter determination model based on the second calculation result data, the first calculation result data, the production sequence and the non-automation factor in each production link, and the parameter determination model is a neural network model. More descriptions regarding the parameter determination model may be found in FIG. 6 and its related descriptions.

Step 240, sending the adjustment parameters to the corresponding production devices to adjust the production devices through the sensor network platform. In some embodiments, step 240 may be performed by the general platform database.

Each of the plurality of sensor network sub-platforms is configured to correspond to each production link or each class of production device. In some embodiments, the sensor network platform sends the adjustment parameters to the corresponding production devices through the sensor network sub-platforms, e.g., the sensor network sub-platform corresponding to the grinding device sends the grinding device adjustment parameters to the grinding device, the sensor network sub-platform corresponding to the emulsification device sends the emulsification device adjustment parameters to the emulsification device, etc.

In some embodiments, the production devices may directly use the adjustment parameters as new production parameters for production to regulate production errors.

Step 250, sending the classified data packets to the user platform through the service platform and displaying the classified data packets on the user platform in a classified manner. In some embodiments, step 250 may be performed by the management platform.

In some embodiments, the service platform may display the data of each classified data packet separately to the user. By displaying the classified data packets to the user, the real-time production of the whole production line may be visually fed back to the user, providing a basis for the user's production decisions.

It should be noted that there is no logical sequential relationship between Step 240 and Step 250, i.e., either step 240 may be performed first and then step 250, or step 250 may be performed first and then step 240, or either of steps 240 and 250 may be performed separately.

In some embodiments of the present disclosure, the adjustment parameters of the production devices are generated based on the first calculation result data and the second calculation result data, the first calculation result is the result of the production simulation for the independent operation of each production device, and the second calculation result is the result of the production simulation for the overall operation of the whole production line. The adjustment parameters of the production device may be determined based on the first calculation result and the second calculation result, making the adjustment parameters more accurate.

It should be noted that the above description of process 200 is for example and illustration purposes only and does not limit the scope of the present disclosure. For those skilled in the art, various amendments and changes can be made to process 200 under the guidance of the present disclosure. However, these amendments and changes remain within the scope of the present disclosure.

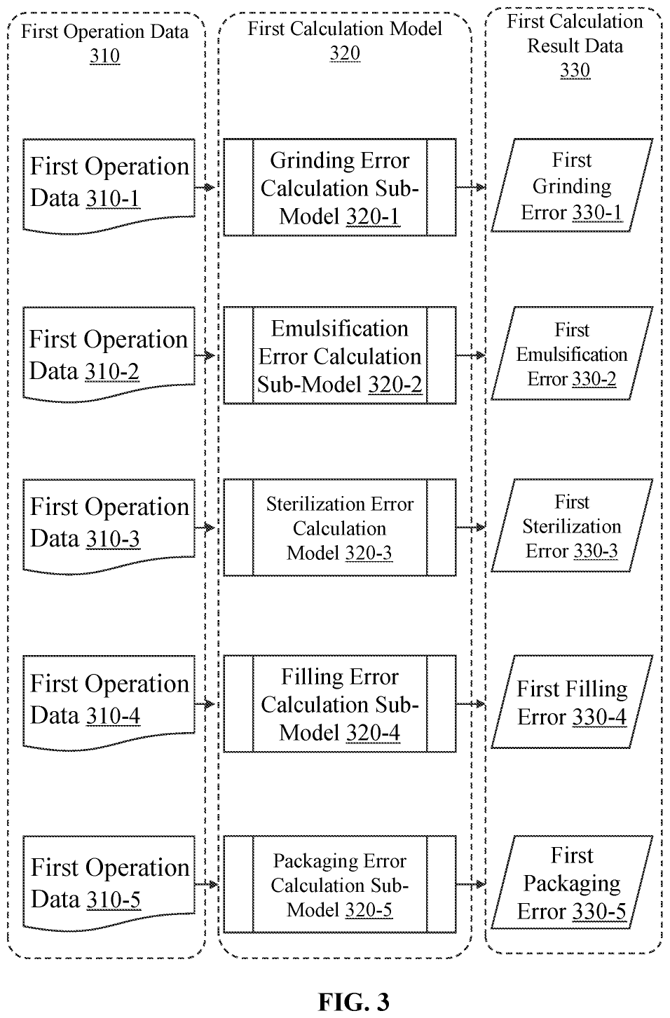

FIG. 3 is an exemplary schematic diagram illustrating generating first calculation result data based on a first calculation model according to some embodiments of the present disclosure.

In some embodiments, each management sub-platform may input the obtained first operation data into the corresponding sub-model of the first calculation model to generate the first calculation result data, respectively.

The first calculation model is configured to simulate a production process of a production line corresponding to a classified data package and generate evaluation data of the output product from the production line as the first calculation result data. In some embodiments, the first calculation model is a machine learning model, such as a deep neural network model.

In some embodiments, as shown in FIG. 3, the first calculation model 320 may include a plurality of sub-models, such as, for example, a grinding error calculation sub-model 320-1, an emulsification error calculation sub-model 320-2, a sterilization error calculation sub-model 320-3, a filling error calculation sub-model 320-4, and a packaging error calculation sub-model 320-5.

In some embodiments, the management sub-platform can input the obtained first operation data into the corresponding sub-models of the first calculation model, respectively, and generate the corresponding production errors of the production link based on the sub-models.

As shown in FIG. 3, the first operation data 310-1 may be input into the corresponding grinding error calculation sub-model 320-1 to generate the first grinding error 330-1 of the grinding link, the first operation data 310-2 may be input into the corresponding emulsification error calculation sub-model 320-2 to generate the first emulsification error 330-2 of the emulsification link, the first operation data 310-3 is input into the corresponding sterilization error calculation sub-model 320-3 to generate the first sterilization error 330-3 of the sterilization link, the first operation data 310-4 is input into the corresponding filling error calculation sub-model 320-4 to generate the first filling error 330-4 of the filling link, and the first operation data 310-5 is input into the corresponding packaging error calculation sub-model 320-5 to generate the first packaging error 330-5 of the packaging link. Further, the first grinding error 330-1, the first emulsification error 330-2, the first sterilization error 330-3, the first filling error 330-4, and the first packaging error 330-5 may be used as the first calculation result data 330. Accordingly, the first calculation result data 330 may represent the production error of each production link in the form of a sequence (i.e., a first sequence), and more descriptions regarding the first sequence may be found in Step 210 and its related description.

The first calculation model may be obtained based on the first training data with a large number of first labels. For example, the first training data with a large number of first labels are input into the initial first calculation model, the loss function is constructed from the labels and the results of the initial first calculation model, and the parameters of the initial first calculation model are updated iteratively by gradient descent or other methods based on the loss function. The model training is completed when the predetermined conditions are satisfied, and the trained first calculation model is obtained. The predetermined conditions may be the convergence of the loss function, the count of iterations reaching a threshold, etc.

The first training data may be historical production data, including raw material information, device parameters, stage standard product information, etc., corresponding to each production link in historical production. In some embodiments, the first training data may be obtained based on historical production records. The first labels may be the real production errors of each production link in the historical production data. In some embodiments, the first labels may be obtained based on historical inspection records in the historical production records, which include records of inspection of the output products of each production link.

In some embodiments, the output of the trained first calculation model may be used as a third training sample for a parameter determination model. More descriptions regarding the training of the parameter determination model may be found in FIG. 6 and its related descriptions.

In some embodiments of the present disclosure, the operation data of a plurality of production links are processed through the model, and thus, the independent operation of the production devices corresponding to each production link can be predicted. The first calculation result data output by the model does not consider the order between the production links and the mutual influence between the production devices, thereby facilitating the subsequent real-time synchronous adjustment of the parameters of the production devices.

FIG. 4 is an exemplary schematic diagram illustrating generating second calculation result data based on a second calculation model according to some embodiments of the present disclosure.

In some embodiments, the general platform database may generate the second calculation result data after performing production calculations on the second operation data. As shown in FIG. 4, the general platform database may input the second operation data 420 into the second calculation model 440, and generate the second grinding error 450-1, the second emulsification error 450-2, the second sterilization error 450-3, the second filling error 450-4, and the second packaging error 450-5 by the second calculation model 440-1. The general platform database may use the second grinding error 450-1, the second emulsification error 450-2, the second sterilization error 450-3, the second filling error 450-4, and the second packaging error 450-5 as the second calculation result data 450.

In some embodiments, the second calculation model is a machine learning model, such as a Long Short-Term Memory network model (LSTM).

In some embodiments, the input of the second calculation model 440 also includes a production sequence 410 and sensor feedback data 430.

The production sequence is formed by the general platform database according to the queue data to sort all the data packets. The queue data is determined based on the second calculation model of all production lines in the object platform and the production process of all production lines in the corresponding object platform.

In some embodiments, the production sequence may include the sequential relationship of each production link corresponding to the first operation data, for example, the production sequence may be (Link1→Link2→Link3→Link4→Link5, Link1 indicates the grinding link, Link2 indicates the emulsification link, Link3 indicates the sterilization link, Link4 indicates the filling link, and Link5 indicates the packaging link). The first operation data of each production link may have an impact on the subsequent production links.

The feedback data of the sensor (also referred to as sensor feedback data) may refer to the feedback data obtained by monitoring the whole production line. The feedback data of the sensor may reflect the comprehensive impact of each device on the whole production line to some extent. In some embodiments, the sensor may include a visual color sensor, a photoelectrochemical sensor, a heavy metal detection sensor, a temperature and humidity sensor, etc. Merely as a way of example, for a production line producing cream cosmetics, the visual color sensor may detect whether foreign substances are mixed in the packaging link. The foreign substance may not be mixed in the packaging link, but in other production links in front of it, and accordingly, the feedback data of the visual color sensor may reflect the impact of other production links on the packaging link. The photoelectrochemical sensor may estimate the antioxidant capacity of cosmetics products in the plurality of production links, which may be influenced by the production in the grinding, emulsification, and sterilization stages at the same time. The heavy metal detection sensor may estimate the heavy metal content of cosmetics products in the plurality of production links, which may be influenced by the production link, such as the grinding link and the filling link, etc. The temperature and humidity sensor may estimate the preparation and storage environment of cosmetics in the plurality of production links, which may be influenced by the production link, such as the filling link and the packaging link, etc.

The second calculation model may be obtained based on a large amount of second training data with the second labels. For example, the second training data with the second label is input to the initial second-acting model, and the loss function is constructed from the second labels and the result of the initial second calculation model, and the parameters of the initial second calculation model are updated iteratively by gradient descent or other methods based on the loss function. The model training is completed when the predetermined conditions are satisfied, and the trained second calculation model is obtained. The predetermined conditions may be the convergence of the loss function, the count of iterations reaching a threshold, etc.

The second training data may be historical production data, including production sequence, raw material information for each production link, device parameters, stage standard finished product information, and feedback data from the sensors. In some embodiments, the second training data can be obtained based on historical production records as well as work logs of the sensor. The second labels may be the real production deviation of each production link in the historical production. In some embodiments, the second labels can be obtained based on historical inspection records.

In some embodiments, the output of the trained second calculation model can be used as a third training sample for the parameter determination model. More descriptions regarding the parameter determination model training may be found in FIG. 6 and its related descriptions.

In some embodiments of the present disclosure, the production sequence, the feedback data from the sensors, and the second operation data are processed by the Long Short Time Memory Network Model (LSTM), and the output of the model corresponding to the previous production link may be used as the input of the model corresponding to the later link, thereby synthetically considering the sequential production sequence of each device on the production line and their mutual influence.

FIG. 5 is an exemplary schematic diagram illustrating determining adjustment parameters of a production device based on a parameter determination model according to some embodiments of the present disclosure.

In some embodiments, as shown in FIG. 5, the general platform database may generate adjustment parameters 560 of the production devices through the parameter determination model 550 based on the first calculation result data 510, the second calculation result data 520, the production sequence 530, and the non-automation factor 540 in each production link.

The non-automation factor for each production link can reflect the level of non-automation in each production link. In some embodiments, the non-automation factor is measured by the manual participation degree and may be a real value between 0 and 1. The higher the manual participation degree, the higher the non-automation factor. In some embodiments, the non-automation factor for each production link may be preset manually in advance, for example, the sterilization link does not require manual participation, the non-automation factor may be 0, and the packaging link requires more manual participation, the non-automation factor may be 0.8.

The parameter determination model may be a model for determining adjustment parameters for each production device. In some embodiments, the parameter determination model includes a neural network model, such as a deep neural network model, etc.

In some embodiments, the adjustment parameters 560 of the production devices may include grinding device adjustment parameters 560-1, emulsification device adjustment parameters 560-2, sterilization device adjustment parameters 560-3, filling device adjustment parameters 560-4, and packaging device adjustment parameters 560-5. The grinding device adjustment parameters may refer to the parameters used to adjust the grinding device. The emulsification device adjustment parameters, sterilization device adjustment parameters, filling device adjustment parameters, and packaging device adjustment parameters are similar to the grinding device adjustment parameters and are not repeated herein.

In some embodiments, the output results of the trained first calculation model and the trained second calculation model may be used as training samples for the parameter determination model. More descriptions regarding the training of the parameter determination model may be found in FIG. 6 and its related descriptions.

In some embodiments of the present disclosure, the prediction of the adjustment parameters of the production device is made by the first calculation result data, the second calculation result data, the production sequence, and the non-automation factor in each production link, which considers not only the individual production situation of each production device, but also the overall feedback data on the whole production line and the influence between the devices, and as well considers the degree of manual participation on the production results, so that the prediction of the adjustment parameters of the production device are more accurate.

FIG. 6 is an exemplary schematic diagram illustrating model training according to some embodiments of the present disclosure.

In some embodiments, as shown in FIG. 6, the general platform database may divide the first training data 610 of the first calculation model into a first sub-set 610-1 and a second sub-set 610-2. The training data included in the first sub-set 610-1 and the second sub-set 610-2 are the same, and it is not required whether the count of training data is the same.

The division of the first and second sub-sets may include a plurality of ways. For example, the general platform database may divide the first training data randomly and equally into two portions as a first sub-set and a second sub-set, respectively. For another example, the general platform database may divide the first training data 610 into a portion with a large count of samples and a portion with a small count of samples, and determine the portion with a large count of samples as the first sub-set and the portion with a small count of samples as the second sub-set, or vice versa.

In some embodiments, the division of the first sub-set and second sub-set are further divided in a manner that includes dividing the first training data at a plurality of times in a plurality of different ways to obtain a plurality of groups of the first sub-sets and a plurality of groups of the second sub-sets.

For example, if the first training data is divided (either equally or unevenly) into 5 portions, e.g., the 1st, 2nd, 3rd, 4th, and 5th portion, and 4 portions of them are combined as the first sub-set and the remaining one portion is the second sub-set, then 5 sets of first sub-sets and 5 sets of second sub-sets may be obtained (e.g., the first group: the first sub-set is 1st, 2nd, 3rd and 4th portion, and the second sub-set is 5th portion; the second group: the first sub-set is 1st, 2nd, 3rd, and 5th portions, and the second sub-set is 4th portion; the third group: the first sub-set is 1st, 2nd, 4th and 5th portions, and the second sub-set is 3rd portion; the fourth group: the first sub-set is the 1st, 3rd, 4th, and 5th portions and the second sub-set is the 2nd portion; the fifth group: the first sub-set is the 2nd, 3rd, 4th, and 5th portions and the second sub-set is the 1st portion), and accordingly, 5 sets of first prediction values may be obtained.

In some embodiments of the present disclosure, a plurality of sets of first sub-sets and the plurality of sets of second sub-sets are obtained by dividing the first training data at a plurality of times, thereby obtaining the plurality of sets of first prediction values and making a count of samples of the third training data larger.

The divided first sub-set and second sub-set may be configured to train the first calculation model and used as the third training data for determining the parameter determination model, respectively. As shown in FIG. 6, the first sub-set 610-1 may be configured to train the initial first calculation model 620-1 to obtain the trained first calculation model 620-2. The second sub-set 610-2 may be configured to determine the third training data 650 for the parameter determination model. Specifically, the second sub-set 610-2 may be input into the trained first calculation model 620-2 to obtain the first prediction value 650-1, and the first prediction value may refer to a plurality of first calculation result data obtained by the trained first calculation model processing the second sub-set.

In some embodiments, as shown in FIG. 6, the general platform database may divide the second training data 630 of the second calculation model into a third sub-set 630-1 and a fourth sub-set 630-2. The training data included in the third sub-set 630-1 and the fourth sub-set 630-2 are the same, and it is not required whether the count of training data is the same. In the same way as the division of the first sub-set and the second sub-set, the division of the third sub-set and the fourth sub-set may include a plurality of ways, the details of which may be found in the above description and will not be repeated herein.

The divided third and fourth sub-sets may be configured to train the second calculation model and used as the third training data for determining the parameter determination model, respectively. As shown in FIG. 6, the third sub-set 630-1 may be configured to train the initial second calculation model 640-1 to obtain the trained second calculation model 640-2. The fourth sub-set 630-2 may be configured to determine the third training data 650 for the parameter determination model. Specifically, the fourth sub-set 630-2 may be input into the trained second calculation model 640-2 to obtain the second prediction value 650-2, and the second prediction value may be a plurality of second calculation result data obtained by the trained second calculation model processing the fourth sub-set.

In some embodiments, as shown in FIG. 6, the general platform database may use the first prediction value 650-1 and the second prediction value 650-2 as the third training data 650 for the parameter determination model, and the third training data 650 is configured to train the parameter determination model. In some embodiments, the third training data 650 for the parameter determination model may also include production sequence 650-3 and non-automation factor 650-4 in each production link. The third training data 650 and its third labels are input into the initial parameter determination model 660 for training to obtain the trained parameter determination model 670. For example, the third training data may be based on a large number of third training samples with third labels, for example, the parameter determination model can be trained based on a large amount of third training data with third labels. Specifically, the third training data with the third labels are input to the initial parameter determination model, a loss function is constructed based on the third labels and the output of the initial parameter determination model, and the parameters of the initial parameter determination model are iteratively updated by gradient descent or other methods based on the loss function. The model training is completed when the predetermined conditions are satisfied, and the trained parameter determination model is obtained. Among them, the preset conditions can be the convergence of the loss function, the count of iterations reaching a threshold value, etc. The third labels may be the production device adjustment parameters for each production link in the historical production data. In some embodiments, the third labels may be obtained based on the production device adjustment records in the historical production data.

In some embodiments of the present disclosure, the training data of the parameter determination model is obtained through the trained first and second calculation models, which can make the parameter determination model better integrate the first calculation result data and the second calculation result data, and learn from these two results, while considering the operation situation of individual production devices and the production situation on the whole production line and the interaction between production devices, which makes the obtained adjustment parameters more accurate.

The basic concepts have been described above, apparently, in detail, as will be described above, and do not constitute a limitation of the specification. Although it is not clearly stated here, technical personnel in the art may be modified, improved, and amended to the present disclosure. The amendments, improvements, and amendments are recommended in the present disclosure, so the amendments, improvements, and amendments of this class still belong to the spirit and scope of the demonstration embodiments of the present disclosure.

At the same time, the present disclosure uses a specific word to describe the embodiments of the present disclosure. For example, “one embodiment”, “One Practice Example”, and/or “some embodiments” means a feature, structure, or feature of at least one embodiment related to the present disclosure. Therefore, it should be emphasized and noticed that in the present disclosure, “one implementation example” “one embodiment” or “an alternative embodiment” that are mentioned in different positions in the present disclosure does not necessarily mean the same embodiment. In addition, some features, structures, or features of one or more embodiments in the present disclosure may be properly combined.

In addition, unless the claims are clearly stated, the order of the processing elements and sequences, the use of digital letters, or the use of other names described in this description are not used to limit the order and method of the present disclosure process and method. Although in the above disclosure, some examples are discussed through various examples that are currently considered useful, it should be understood that the details of this type of detail are only explained. The additional claims are not limited to the implementation examples of the disclosure. The requirements are required to cover all the amendments and equivalent combinations that meet the essence and scope of the implementation of the present disclosure. For example, although the implementation of various components described above may be embodied in a hardware device, it may also be performed as a software-only solution, e.g., an installation on an existing server or mobile device.

Similarly, it should be noted that to simplify the expressions disclosed in this disclosure and thus help the understanding of one or more embodiments of the invention, in the foregoing description of the embodiments of this disclosure, various features may sometimes be combined into one embodiment, in the drawings or descriptions thereof. However, this disclosure method does not mean that the feature required by the object of this description is more than the feature mentioned in the claims. Rather, claimed subject matter may lie in less than all features of a single foregoing disclosed embodiment.

Some embodiments use numbers with description ingredients and attributes. It should be understood that the number described by the embodiment is used in some examples. Modify. Unless otherwise stated, “approximately”, “approximate”, or “generally” indicates that the count of numbers allows ±20% of changes. Correspondingly, in some embodiments, the value parameters used in the manual and claims are similar values. The approximate value can be changed according to the feature of individual embodiments. In some embodiments, the numerical parameters should consider the effective digits specified and use the method of general digits. Although some embodiments of the present disclosure are used to confirm the range and parameters of its range breadth, in the specific embodiment, the setting of such values is as accurate as possible within the feasible range.

Each patent, patent application, patent application public, and other materials cited for the present disclosure, such as articles, books, instructions, publications, documents, etc., are hereby incorporated into this instruction as a reference. Except for the inconsistent content of the present disclosure or the application history documents, there are no restricted documents (currently or attached to the present disclosure) with the widest range of claims for this instruction. It should be explained that if the use of description, definition, and/or terminology in this instruction manual is inconsistent or in conflict with the content described in this description, the use of the description, definition, and/or terms of the present disclosure shall prevail as shall prevail.

Finally, it should be understood that the embodiments described in the present disclosure are only used to illustrate the principle of the embodiments of this description. Other deformation may also belong to the scope of the present disclosure. Therefore, as an example, rather than restrictions, the replacement configuration of the embodiment of the present disclosure may be consistent with the teaching of the present disclosure. Correspondingly, the embodiments of the present disclosure are not limited to the implementation and description of the present disclosure.

What is claimed is:

1. An intelligent manufacturing Industrial Internet of Things based on a platform network in a post-sub type, comprising:
a management platform, including a plurality of management sub-platforms and a general platform database, wherein
each of the management sub-platforms performs production calculation based on first operation data to generate first calculation result data, and send the first calculation result data to the general platform database; and
the general platform database performs the production calculation based on second operation data to generate second calculation result data, and generates adjustment parameters of production devices according to the second calculation result data and the first calculation result data.

2. The intelligent manufacturing Industrial Internet of Things based on the platform network in the post-sub type of claim 1, wherein the intelligent manufacturing Industrial Internet of Things further includes a service platform and a sensor network platform, the service platform, the management platform, and the sensor network platform interact in sequence;
the sensor network platform includes a general database of the sensor network platform and a plurality of sensor network sub-platforms of the sensor network platform,
the general database of the sensor network platform is configured to receive operation data of all production devices in an object platform, and classify and packet the operation data according to a production line where the production devices are located to form classified data packets; and
each of the plurality of sensor network sub-platforms is configured to receive the classified data packets in different types from the general database of the sensor network platform;
the general platform database of the management platform is configured to interact with the sensor network sub-platforms through different ports and receive the classified data packets as the second operation data;
each of the plurality of management sub-platforms of the management platform is configured to receive a corresponding classified data packet from the general platform database as the first operation data;
the general platform database sends the adjustment parameters to corresponding production devices through the sensor network sub-platforms to adjust the production devices; and
the service platform sends the classified data packets to the user platform and displays the classified data packets to the user platform in a classified manner.

3. The intelligent manufacturing Industrial Internet of Things based on the platform network in the post-sub type of claim 2, wherein the service platform includes:
a plurality of service sub-platforms, each of which is configured to receive a corresponding classified data packet and send the corresponding classified data packet to the user platform.

4. The intelligent manufacturing Industrial Internet of Things based on the platform network in the post-sub type of claim 2, wherein each of the management sub-platforms are configured with a first calculation model corresponding to each classified data packet;
each of the management sub-platforms inputs received operation data in the corresponding classified data packet into the first calculation model, and receives output data output by the first calculation model as the first calculation result data; and
the first calculation model simulates a production process of the production line corresponding to the classified data packet according to the classified data packet and generates evaluation data of output products in the production line as the first calculation result data.

5. The intelligent manufacturing Industrial Internet of Things based on the platform network in the post-sub type of claim 2, wherein the general platform database is configured with a second calculation model corresponding to all production lines in the object platform and production processes corresponding to all production lines in the object platform are used as queue data;
the general platform database sorts all the classified data packets according to the queue data to form a production sequence, and inputs the classified data packets into the second calculation model in sequence from the front of the production sequence; and
each time receiving a classified data packet, the second calculation model simulates production processes for all classified data packets that have been received, and generates evaluation data of products as second calculation result data corresponding to the classified data packet.

6. The intelligent manufacturing Industrial Internet of Things based on the platform network in the post-sub type of claim 5, wherein when generating the adjustment parameters of the production devices according to the second calculation result data and the first calculation result data, for each classified data packet, the general platform database obtains a difference between second calculation result data and first calculation result data corresponding to the same classified data packet; and
the general platform database averages the second calculation result data and the first calculation result data to form estimated production results, and generates the adjustment parameters of the production devices according to the estimated production results.

7. The intelligent manufacturing Industrial Internet of Things based on the platform network in the post-sub type of claim 1, wherein each of the management sub-platforms has a corresponding first calculation model, and to generate the first calculation result data, each of the management sub-platforms further
inputs the obtained first operation data into sub-models of the corresponding first calculation model, respectively, wherein the first calculation model includes a grinding error calculation sub-model, an emulsification error calculation sub-model, a sterilization error calculation sub-model, a filling error calculation sub-model, and a packaging error calculation sub-model, and the first calculation model is a machine learning model;
generates a first grinding error of a grinding link based on the grinding error calculation sub-model;
generates a first emulsification error of an emulsification link based on the emulsification error calculation sub-model;
generates a first sterilization error of a sterilization link based on the sterilization error calculation model;
generates a first filling error of a filling link based on the filling error calculation sub-model;
generates a first packaging error of a packaging link based on the packaging error calculation sub-model; and
takes the first grinding error, the first emulsification error, the first sterilization error, the first filling error, and the first packaging error as the first calculation result data.

8. The intelligent manufacturing Industrial Internet of Things based on the platform network in the post-sub type of claim 7, wherein to generate second calculation result data, the general platform database further
inputs the second operation data into a second calculation model, wherein the second calculation model is a long-short term memory model; and
generates a second grinding error, a second emulsification error, a second sterilization error, a second filling error, and a second packaging error through the second calculation model, and takes the second grinding error, the second emulsification error, the second sterilization error, the second filling error, and the second packaging error as the second calculation result data.

9. The intelligent manufacturing Industrial Internet of Things based on the platform network in the post-sub type of claim 8, wherein the generating adjustment parameters of production devices according to the second calculation result data and the first calculation result data includes:
generating the adjustment parameters of the production devices through a parameter determination model based on the second calculation result data, the first calculation result data, a production sequence, and a non-automation factor in each production link, wherein the parameter determination model is a neural network model.

10. The intelligent manufacturing Industrial Internet of Things based on the platform network in the post-sub type of claim 9, wherein the parameter determination model is obtained through the following operations including:
dividing first training data of the first calculation model into a first sub-set and a second sub-set, and training an initial first calculation model based on the first sub-set to obtain a trained first calculation model;
inputting the second sub-set into the trained first calculation model to obtain a first prediction value;
dividing second training data of the second calculation model into a third sub-set and a fourth sub-set, and training an initial second calculation model based on the third sub-set to obtain a trained second calculation model;
inputting the second sub-set into the trained second calculation model to obtain a second prediction value; and
taking the first prediction value and the second prediction value as third training data of the parameter determination model.

11. A control method of an intelligent manufacturing Industrial Internet of Things based on a platform network in a post-sub type, wherein the intelligent manufacturing Industrial Internet of Things comprises a service platform, a management platform, and a sensor network platform interacting in sequence, and the management platform includes a plurality of management sub-platforms and a general platform database, and the method comprises:
performing, by each of the management sub-platforms, production calculation based on first operation data to generate first calculation result data, and sending the first calculation result data to the general platform database;
performing, by the general platform database, the production calculation based on second operation data to generate second calculation result data, and generating adjustment parameters of a production devices according to the second calculation result data and the first calculation result data.

12. The control method of the intelligent manufacturing Industrial Internet of Things based on the platform network in the post-sub type of claim 11, wherein
the sensor network platform includes a general database of the sensor network platform and a plurality of sensor network sub-platforms of the sensor network platform;
the general database of the sensor network platform is configured to receive operation data of all production devices in an object platform, and classify and packet the operation data according to a production line where the production devices are located to form classified data packets; and
each of the plurality of sensor network sub-platforms is configured to receive different types of the classified data packets in different types from the general database of the sensor network platform;
the general platform database of the management platform is configured to interact with the sensor network sub-platforms through different ports and receive the classified data packets as the second operation data;
each of the plurality of management sub-platforms of the management platform is configured to receive a corresponding classified data packet from the general platform database as the first operation data; and
the control method includes: sending, by the general platform database, the adjustment parameters to corresponding production devices through the sensor network sub-platforms to adjust the production devices; and
sending, by the service platform, the classified data packets to the user platform and displaying the classified data packets to the user platform in a classified manner.

13. The control method of the intelligent manufacturing Industrial Internet of Things based on the platform network in the post-sub type of claim 12, wherein the service platform includes:
a plurality of service sub-platforms, each of which is configured to receive a corresponding classified data packet and send the corresponding classified data packet to the user platform.

14. The control method of the intelligent manufacturing Industrial Internet of Things based on the platform network in the post-sub type of claim 12, wherein each of the management sub-platforms is configured with a first calculation model corresponding to the classified data packet, and the control method includes:
by the each of the management sub-platform, inputting received operation data in the corresponding classified data packet into the first calculation model, and receiving output data output by the first calculation model as the first calculation result data; and
by the first calculation model, simulating a production process of the production line corresponding to the classified data packet according to the classified data packet, and generating evaluation data of output products in the production line as the first calculation result data.

15. The control method of the intelligent manufacturing Industrial Internet of Things based on the platform network in the post-sub type of claim 12, wherein the general platform database is configured with a second calculation model corresponding to all production lines in the object platform and production processes corresponding to all production lines in the object platform are used as queue data, the control method includes:
by the general platform database, sorting all the classified data packets according to the queue data to form a production sequence, and inputting the classified data packets into the second calculation model in sequence from the front of the production sequence; and
by the second calculation model, each time receiving a classified data packet, simulating production processes for all classified data packets that have been received, and generating evaluation data of products as the second calculation result data corresponding to the classified data packet.

16. The control method of the intelligent manufacturing Industrial Internet of Things based on the platform network in the post-sub type of claim 15, comprising:
when generating the adjustment parameters of the production device according to the second calculation result data and the first calculation result data, for each classified data packet, obtaining, by the general platform database, a difference between second calculation result data and first calculation result data corresponding to the same classified data packet; and
averaging, by the general platform database, the second calculation result data and the first calculation result data to form estimated production results, and generating the adjustment parameters of the production devices according to the estimated production results.

17. The control method of the intelligent manufacturing Industrial Internet of Things based on the platform network in the post-sub type of claim 11, wherein the intelligent manufacturing Industrial Internet of Things is configured for a production line of cream cosmetics, each of the management sub-platforms has a corresponding first calculation model, and the generating the first calculation result data includes:
by each of the management sub-platforms, inputting the obtained first operation data into sub-models of the corresponding first calculation model, respectively, wherein the first calculation model includes a grinding error calculation sub-model, an emulsification error calculation sub-model, a sterilization error calculation sub-model, a filling error calculation sub-model, and a packaging error calculation sub-model, and the first calculation model is a machine learning model;
generating a first grinding error of a grinding link based on the grinding error calculation sub-model;
generating a first emulsification error of an emulsification link based on the emulsification error calculation sub-model;
generating a first sterilization error of a sterilization link based on the sterilization error operator model;
generating a first filling error of a filling link based on the filling error calculation sub-model;
generating a first packaging error of a packaging link based on the packaging error operator sub-model; and
taking the first grinding error, the first emulsification error, the first sterilization error, the first filling error, and the first packaging error as the first calculation result data.

18. The control method of the intelligent manufacturing Industrial Internet of Things based on the platform network in the post-sub type of claim 17, wherein the generating second calculation result data includes:
by the general platform database, inputting the second operation data into a second calculation model, wherein the second calculation model is a long-short term memory model; and
generating a second grinding error, a second emulsification error, a second sterilization error, a second filling error, and a second packaging error through the second calculation model, and taking the second grinding error, the second emulsification error, the second sterilization error, the second filling error, and the second packaging error as the second calculation result data.

19. The control method of the intelligent manufacturing Industrial Internet of Things based on the platform network in the post-sub type of claim 18, wherein the generating adjustment parameters of production devices according to the second calculation result data and the first calculation result data includes:
generating the adjustment parameters of the production devices through a parameter determination model based on the second calculation result data, the first calculation result data, a production sequence, and a non-automation factor in each production link, wherein the parameter determination model is a neural network model.

20. The control method of the intelligent manufacturing Industrial Internet of Things based on the platform network in the post-sub type of claim 19, wherein the parameter determination model is obtained through the following operations including:
dividing first training data of the first calculation model into a first sub-set and a second sub-set, and training an initial first calculation model based on the first sub-set to obtain a trained first calculation model;
inputting the second sub-set into the trained first calculation model to obtain a first prediction value;
dividing second training data of the second calculation model into a third sub-set and a fourth sub-set, and training an initial second calculation model based on the third sub-set to obtain a trained second calculation model;
inputting the second sub-set into the trained second calculation model to obtain a second prediction value; and
taking the first prediction value and the second prediction value as third training data of the parameter determination model.
